(19) United States
(12) Patent Application Publication
(10) Pub. No.: US 2026/0274280 A1
(43) Pub. Date: Sep. 17, 2026

(54) METHOD AND DEVICE FOR DETECTING CONTACT OF HANDS WITH A STEERING WHEEL OF A VEHICLE

(71) Applicant: VOLKSWAGEN AKTIENGESELLSCHAFT, Wolfsburg (DE)

(72) Inventors: Jonas KASTE, Alfeld (DE); Felix STAHL, Braunschweig (DE); Felix KALLMEYER, Wolfsburg (DE)

(21) Appl. No.: 19/472,914

(22) PCT Filed: Apr. 9, 2024
(86) PCT No.: PCT/EP2024/059611

§ 371 Date: Oct. 6, 2025

(30) Foreign Application Priority Data
Apr. 18, 2023 (DE) 10 2023 203 516.2

(51) Int. Cl. B60W 50/08; B60W 30/14; G01L 5/22

(52) U.S. Cl. CPC B60W 50/082; B60W 30/14; G01L 5/221; B60W 2540/223

(57) ABSTRACT

A method for detecting contact of hands with a steering wheel of a transportation vehicle, wherein a test signal is applied to the steering wheel by an actuator, wherein a reaction on the steering wheel to the test signal is detected by a sensor, and wherein a decision is made, on the basis of the detected reaction, as to whether at least one hand of the driver is in contact with the steering wheel or not, wherein the test signal is applied according to predefined torque curve, and wherein the torque curve initially rises rapidly to a predefined minimum torque which corresponds to a minimum friction of a steering system of the transportation wheel. Also disclosed is a device for detecting contact of hand with a steering wheel of a transportation vehicle.

### PRIORITY CLAIM AND CROSS REFERENCE

This patent application is a U.S. National Phase of International Patent Application No. PCT/EP2024/059611, filed 9 Apr. 2024, which claims priority to German Patent Application No. 10 2023 203 516.2, filed 18 Apr. 2023, the disclosures of which are incorporated herein by reference in their entireties.

### SUMMARY

Illustrative embodiments relate to a method and to a device for detecting contact of hands with a steering wheel of a transportation vehicle.

### BRIEF DESCRIPTION OF THE DRAWINGS

Disclosed embodiments will be described in more detail below with reference to drawings, in which:

FIG. 1 shows a schematic representation of one exemplary embodiment of the device for detecting contact of hands with a steering wheel of a transportation vehicle;

FIG. 2a shows a schematic representation for illustrating a conventional test signal in the time curve (prior art);

FIG. 2b shows a schematic representation for illustrating a test signal in the time curve; and

FIG. 3 shows a schematic representation for illustrating a further exemplary embodiment of the method and of the device.

### DETAILED DESCRIPTION

In modern transportation vehicles, sensors are used to monitor a driver activity. For example, by a capacitive sensor on a steering wheel of the transportation vehicle, it can be determined whether or not at least one hand of the driver is located on the steering wheel (also referred to as hands-on detection). On the basis of the capacitively collected sensor data, for example, a multi-stage status can be determined (for example, no contact, lightly gripped left/right to firmly gripped on both sides, etc.), which is transmitted, for example, to assistance functions, such as a longitudinal and/or transverse guidance assistance system. For example, such a status can be fed to an Adaptive Cruise Control (ACC) as input, wherein, when contact of at least one hand with the steering wheel has been detected, for example, a starting process for following a preceding transportation vehicle is released. Furthermore, driver observation cameras are known, which can detect a driver activity.

In addition, there are methods that detect a driver activity, in particular in relation to hands-on detection, by methods of artificial intelligence or rules-based approaches. For example, a method of artificial intelligence, in particular an artificial neural network, can be trained to carry out a hands-on detection on the basis of a detected torque, a detected steering angle, and/or changes in these variables. The rules-based approach, on the other hand, passively evaluates steering signals (for example, steering torque, steering speed, and/or steering angle) in relation to threshold values and/or signal curves or actively operates with a quick-action switch, in which a test signal is impressed on the steering wheel by an actuator, which test signal is to induce a counter torque by hands arranged on the steering wheel, which can be detected by a sensor. As soon as such a counter torque has been detected, it is assumed that at least one hand is arranged on the steering wheel. A method of this type is known, for example, from DE 10 2013 209 459 A1.

The disclosed embodiments improve a method and a device for detecting contact of hands with a steering wheel of a transportation vehicle.

In particular, the disclosed embodiments relate to a method for detecting contact of hands with a steering wheel of a transportation vehicle, wherein a test signal is impressed on the steering wheel by an actuator, wherein a reaction on the steering wheel to the test signal is detected by a sensor, and wherein a decision is made, on the basis of the detected reaction, as to whether at least one hand of the driver is in contact with the steering wheel or not, wherein the test signal is impressed according to a predefined torque curve, and wherein the torque curve initially abruptly increases to a predefined minimum torque, which corresponds to a minimum friction of a steering system of the transportation vehicle.

Disclosed embodiments further relate, in particular, to a device for detecting contact of hands with a steering wheel of a transportation vehicle, comprising an actuator, which is designed to impress a test signal on the steering wheel, a sensor, which is designed to detect a reaction to the test signal on the steering wheel, and a control unit, wherein the control unit is designed to trigger the impression of the test signal, evaluate a detected reaction, and, on the basis of the detected reaction, reach a decision as to whether or not at least one hand of the driver is in contact with the steering wheel, wherein the test signal is impressed according to a predefined torque curve, and wherein the torque curve initially abruptly increases to a predefined minimum torque, which corresponds to a minimum friction of a steering system of the transportation vehicle.

The method and the device make it possible to overcome system-related friction of the steering system in the shortest time, such that a counter-reaction to an impressed test signal can be detected nearly without delay, without a driver, who has their hands on the steering wheel, perceiving the test signal as disruptive. This is achieved in that a jump takes place only up to the predefined minimum torque; subsequently, however, in particular, only a slower increase in the torque takes place. This is based on the concept that the driver cannot perceive the test signal up to the point of overcoming the minimum friction, i.e., only after the minimum friction has been overcome does the test signal need to be designed not to be disruptive to the driver. Furthermore, each steering system has an individual friction. For steering systems installed in transportation vehicles, it is possible, however, to define a tolerance range, which includes the minimum and maximum possible friction of a plurality of similar steering systems. On the basis thereof, in particular, the minimum possible friction of the tolerance range is predefined as the minimum friction for the method and the device. As a result, when the test signal is impressed, it is possible to immediately overcome this system-related minimum friction by the abrupt increase, such that a system reaction can take place faster and a reaction on the steering wheel induced by hands arranged on the steering wheel can be detected in shortest possible.

One benefit of the method and of the device is that the reaction (i.e., in particular, of a counter torque on the steering wheel induced by at least one hand) can be detected faster. A decision as to whether or not at least one hand of the driver is in contact with the steering wheel can also be made faster as a result. Consequently, a corresponding signal can also be provided to a driver assistance function faster, which increases driver comfort.

Another benefit is that, due to the method and the device, for example, a capacitive sensor on the steering wheel can be omitted, since reliable hands-on detection can also be carried out without this. As a result, complexity, costs, and installation space can be reduced.

The actuator is, in particular, an actuator of a steering system, for example, an electric machine of the steering system. The sensor is, in particular, a sensor of the steering system, for example, a torque sensor and/or a steering angle sensor on a steering assistance unit. In principle, multiple actuators and/or multiple sensors can also be provided.

Parts of the device, in particular the control unit, can be designed individually or combined, as a combination of hardware and software, for example, as program code, which is run on a microcontroller or microprocessor. It can also be provided, however, that parts are designed individually or combined as an Application-Specific Integrated Circuit (ASIC) and/or a Field-Programmable Gate Array (FPGA).

In at least one exemplary embodiment, the method is carried out only in the case when it cannot be otherwise reliably determined whether at least one hand is arranged on the steering wheel. As a result, the method can be started as necessary. In particular, as a result, the impression of the test signal can be omitted when it has already been reliably determined by another sensor (for example, a capacitive sensor or driver camera) or another method (for example, by artificial intelligence and/or a rules-based approach) that at least one hand is in contact with the steering wheel.

In at least one exemplary embodiment, when the minimum torque is reached, the torque curve increases with a predefined first slope to a predefined value. As a result, it can be achieved that the test signal on the steering wheel is not perceived as disruptive by a driver who has their hands on the steering wheel yet can nevertheless induce a reaction in the shortest possible time. The first slope can be determined, for example, by empirical test series.

In at least one exemplary embodiment, after a predefined time duration, the torque curve decreases with a second slope at least to the predefined minimum torque. As a result, the impressed test signal can be slowly returned to zero. This return can also be designed, as a result, in such a way that this is not perceived as disruptive by the driver. The second slope can be determined, for example, by empirical test series. The second slope can also correspond to the first slope with reversed signs.

In at least one exemplary embodiment, when a counter torque is detected, the torque curve decreases with a third slope at least to the predefined minimum torque. As a result, the case in which a reaction is not induced or detected, and the case in which a counter torque is detected as the reaction, can be handled differently. In particular, in the case in which a counter torque is detected, it is important to ensure that the (third) slope is designed such that the change in torque at the steering wheel is not perceived as disruptive.

In at least one further exemplary embodiment, the absolute value of the third slope is lower than that of the second slope. As a result, when a counter torque is detected, the test signal can be returned to zero more slowly than in the case in which a counter torque was not detected.

In at least one exemplary embodiment, on the basis of the decision that is made, a release signal for at least one assistance system is generated and made available, wherein a release takes place when at least one hand of the driver is in contact with the steering wheel. As a result, a release of assistance systems can be controlled in an open loop.

In particular, in one exemplary embodiment, the release signal releases a (re-)starting process for an ACC.

In at least one exemplary embodiment, the method is carried out only in the case when at least one assistance system transmits a readiness signal. As a result, the method can be started as necessary. For example, an ACC can transmit such a readiness signal when, at a standstill, a preceding transportation vehicle starts up again and following would be possible. Furthermore, it can also be provided that the method is started only when the readiness signal has been transmitted and, in addition, it could not be otherwise determined whether at least one hand is arranged on the steering wheel.

Further features of the exemplary embodiments of the device can be gathered from the description of exemplary embodiments of the method. The benefits of the device are the same, in each case, as for the exemplary embodiments of the method.

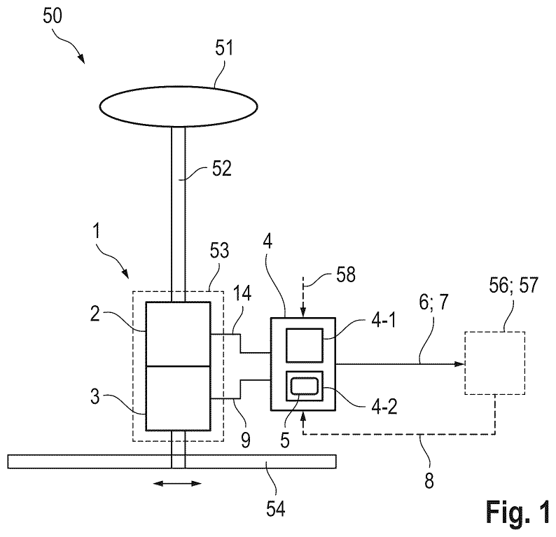

FIG. 1 shows a schematic representation of one exemplary embodiment of the device 1 for detecting contact of hands with a steering wheel 51 of a transportation vehicle. The device 1 is, in particular, part of a steering system 50 of the transportation vehicle. The steering system 50 comprises, in addition to the steering wheel 51, a steering rod 52, a steering assistance unit 53, and a toothed rack 54. The device 1 is designed, in particular, to carry out the method described in this disclosure, wherein the method is explained in greater detail with reference to the device 1.

The device 1 comprises an actuator 2, a sensor 3, and a control unit 4. The actuator 2 can be an actuator of the steering assistance unit 53, for example, an electric machine. The actuator 2 is designed to impress a test signal 14 on the steering wheel 51. The test signal 14 is, in particular, a torque which is impressed on the steering wheel 51. The sensor 3 is designed to detect a reaction 9 to the test signal 14 on the steering wheel 51. The sensor 3 can be, for example, a torque sensor on a steering assistance unit 53 of the steering system 50.

The control unit 4 comprises, for example, a computing device 4-1, for example, a microcontroller or a microprocessor, and a memory 4-2. The control unit 4 is designed to trigger the impression of the test signal 14. To this end, the control unit 4 activates the actuator 2 accordingly. Furthermore, the control unit 4 is designed to evaluate a detected reaction 9 and to make a decision 6 on the basis of the detected reaction 9 as to whether or not at least one hand of the driver is in contact with the steering wheel 51.

The test signal 14 is impressed according to a predefined torque curve 5, which is stored, for example, in a memory 4-2 of the control unit 4. The torque curve 5 is implemented by the actuator 2. The torque curve 5 initially abruptly increases to a predefined minimum torque, which corresponds to a minimum friction of a steering system 50 of the transportation vehicle.

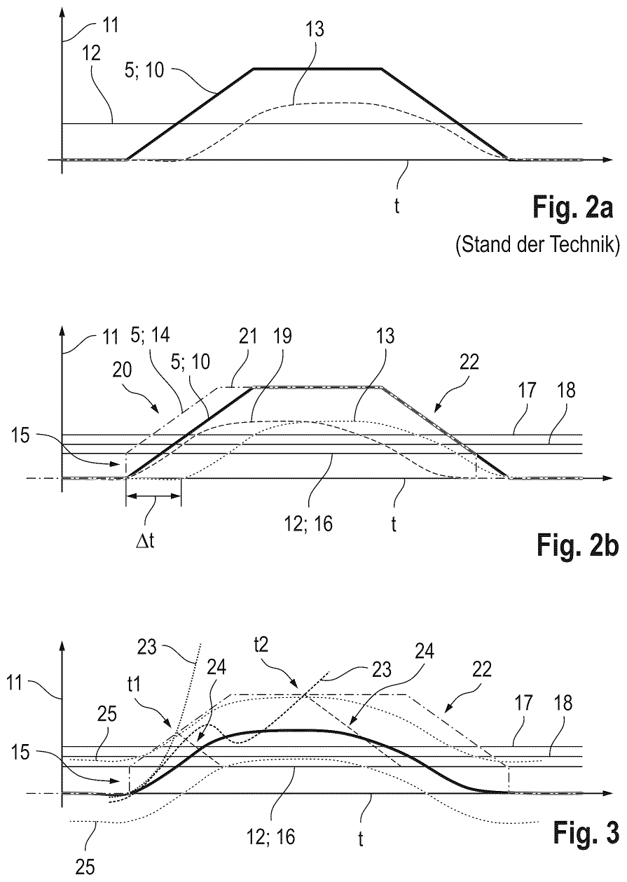

FIG. 2a shows a schematic representation for illustrating a conventional test signal 10 in the time curve (time axis t), as is used in the prior art. The test signal 10 corresponds to a torque curve 5. This conventional test signal 10 comprises a ramp, in which an impressed torque 11 is increased linearly from zero to a predefined value, is held there for a predefined time duration, and is subsequently linearly returned to zero. A system-related minimum friction 12 must be overcome. A system response 13 of the steering system is delayed in relation to the conventional test signal 10.

FIG. 2b shows a schematic representation for illustrating a test signal 14 in the time curve (time axis t). The test signal 14 corresponds to a torque curve 5. The test signal 14 has a jump 15 at the start, namely a jump to a predefined minimum torque 16, which corresponds to a minimum friction 12 of the steering system of the transportation vehicle. Furthermore, a maximum friction 17 of the steering system and an average value 18 of the friction are also shown for illustration, wherein these values are, in particular statistically, determined and relate, in particular, to a plurality of installed steering systems of the same design.

Since, in addition to the test signal 14, the conventional test signal 10 is also shown in FIG. 2b, the benefit of a faster detection of a reaction on the steering wheel is also apparent. Thus, the system response 19 during the impression of the test signal 14 takes place at a time At sooner than the system response 13 during the impression of the conventional test signal 10, since the minimum friction 12 is more quickly overcome by the jump 15.

It can be provided that the method is carried out only in the case when it cannot be otherwise reliably determined whether at least one hand is arranged on the steering wheel 51. To this end, the control unit 4 receives, for example, a transmitted signal 58 (FIG. 1) in order to start the method, or generates such a signal 58 itself when, for example, a method of artificial intelligence or a rules-based approach, which can also be carried out on the control unit 4, cannot reliably determine on the basis of detected sensor data of the sensor 3 (and/or further sensors) whether or not a hand is in contact with the steering wheel 51.

It can be provided that, when the minimum torque 16 is reached, the torque curve 5 can increase with a predefined first slope 20 (FIG. 2b) to a predefined (maximum) value 21.

It can be provided that, after a predefined time duration, the torque curve 5 can decrease with a second slope 22 (FIG. 2b) at least to the predefined minimum torque 16.

The first slope 20, the predefined value 21, and the second slope 22 can be determined, for example, on the basis of empirical test series in which it is determined, in particular, at which slopes 20, 22 a change in the torque on the steering wheel is not yet perceived as disruptive.

FIG. 3 shows a schematic representation for illustrating a further exemplary embodiment of the method and of the device. In this exemplary embodiment, when a counter torque 23 is detected, the torque curve 5 decreases with a third slope 24 at least to the predefined minimum torque 16. In principle, the curve of the test signal 14, or of the torque curve 5, in this exemplary embodiment is otherwise the same as that shown in FIG. 2b. The same reference signs designate the same terms and features. By way of example, for illustration purposes, two different curves with counter torques 23 are shown, which can arise when the driver has one hand or both hands on the steering wheel. The counter torque 23 is, in particular, detected when a tolerance range 25 about the system response 19 is exceeded (or fallen below). This is shown schematically for the points in time t1 and t2 for the two exemplified curves of the counter torques 23. After the counter torques 23 are detected, the torque curve 5 is adapted, such that this decreases with the third slope 24 at least to the predefined minimum torque 16, as is illustrated in FIG. 3 by way of example. The third slope 24 can have the same value as the second slope 22.

It can also be provided that the absolute value of the third slope 24 is lower than that of the second slope 22. As a result, the test signal 14 can be returned in an even more gentle manner.

It can be provided that, on the basis of the decision 6 (FIG. 6) that is made, a release signal 7 for at least one assistance system 56 is generated and made available, wherein a release takes place when at least one hand of the driver is in contact with the steering wheel 51. The release signal 7 can be subsequently transmitted to the assistance system 56.

It can be further provided that the release signal 7 releases a (re-)starting process for an adaptive cruise control 57.

It can be provided that the method is carried out only in the case when at least one assistance system 56 transmits a readiness signal 8. It can also be provided that the signals 8, 58 are logically related and the method is carried out only when both signals are present.

The torque curves 5 that are shown are selected merely by way of example for illustrating the disclosed method and can, in principle, also be designed differently, in particular in terms of the slopes 20, 22, 24 and the predefined value 21.

### LIST OF REFERENCE SIGNS

1 device
2 actuator
3 sensor
4 control unit
4-1 computing device
4-2 memory
5 torque curve
6 decision
7 release signal
8 readiness signal
10 conventional test signal
11 torque
12 minimum friction
13 system response (conventional test signal)
14 test signal
15 jump
16 minimum torque
17 maximum friction
18 average value (friction)
19 system response (test signal)
20 first slope
21 predefined (maximum) value
22 second slope
23 counter torque
24 third slope
25 tolerance range
50 steering system
51 steering wheel
52 steering rod
53 steering assistance unit
54 toothed rack
56 assistance system
57 adaptive cruise control (ACC)
58 signal
t time
t1, t2 points in time

1. A method for detecting contact of hands with a steering wheel of a vehicle, the method comprising:
impressing a test signal on the steering wheel by an actuator;
detecting a reaction on the steering wheel to the test signal by a sensor; and
deciding, based wherein on the the detected reaction whether at least one hand of the driver is in contact with the steering wheel,
wherein the test signal is impressed according to a predefined torque curve, and
wherein the torque curve initially, abruptly increases to a predefined minimum torque, which corresponds to a minimum friction of a steering system of the vehicle.

2. The method of claim 1, wherein the method is carried out only in response to it not being otherwise reliably determined whether at least one hand is arranged on the steering wheel.

3. The method of claim 1, wherein, in response to the minimum torque being reached, the torque curve increases with a predefined first slope to a predefined value.

4. The method of claim 1, wherein, after a predefined time duration, the torque curve decreases with a second slope at least to the predefined minimum torque.

5. The method of claim 4, wherein, in response to detection of a counter torque the torque curve decreases with a third slope at least to the predefined minimum torque.

6. The method of claim 5, wherein an absolute value of the third slope is lower than that of the second slope.

7. The method of claim 1, further comprising generating and making available a release signal for at least one assistance system based on the decision of whether at least one hand of the driver is in contact with the steering wheel such that a release of the at least one assistance system takes place when at least one hand of the driver is in contact with the steering wheel.

8. The method of claim 7, wherein the release signal releases a starting process or re-starting process for an adaptive cruise control.

9. The method of claim of 1, wherein the method is carried out only in response to at least one assistance system transmitting a readiness signal.

10. A device for detecting contact of hands with a steering wheel of a vehicle, the device comprising:
an actuator configured to impress a test signal on the steering wheel,
a sensor configured to detect a reaction to the test signal on the steering wheel, and
a control unit, configured to trigger the impression of the test signal, evaluate a detected reaction, and make a decision on the basis of the detected reaction as to whether at least one hand of the driver is in contact with the steering wheel,
wherein the test signal is impressed according to a predefined torque curve, and
wherein the torque curve initially, abruptly increases to a predefined minimum torque, which corresponds to a minimum friction of a steering system of the vehicle.

11. The device of claim 1, wherein the device operates only in response to it not being otherwise reliably determined whether at least one hand is arranged on the steering wheel.

12. The device of claim 10, wherein, in response to the minimum torque being reached, the torque curve increases with a predefined first slope to a predefined value.

13. The device of claim 10, wherein, after a predefined time duration, the torque curve decreases with a second slope at least to the predefined minimum torque.

14. The device of claim 13, wherein, in response to detection of a counter torque, the torque curve decreases with a third slope at least to the predefined minimum torque.

15. The device of claim 14, wherein an absolute value of the third slope is lower than that of the second slope.

16. The device of claim 10, wherein the device generates and makes available a release signal for at least one assistance system based on the decision of whether at least one hand of the driver is in contact with the steering wheel such that a release of the at least one assistance system takes place when at least one hand of the driver is in contact with the steering wheel.

17. The device of claim 16, wherein the release signal releases a starting process or re-starting process for an adaptive cruise control.

18. The device of claim 10, wherein the device operates only in response to at least one assistance system transmitting a readiness signal.
